(19) United States
(12) Patent Application Publication
(10) Pub. No.: US 2012/0066669 A1
(43) Pub. Date: Mar. 15, 2012

(54) CREATING A SUPERSEDING SOFTWARE RELEASE

(75) Inventors: JOHN BOUZAKIS, Poughkeepsie, NY (US); Dhruti Ritesh Motipara, Austin, TX (US); Anais Graciela Rivera, Austin, TX (US); Kurt Chien-Hua Su, Austin, TX (US)

(73) Assignee: International Business Machines Corporation, Armonk, NY (US)

(21) Appl. No.: 12/881,639

(22) Filed: Sep. 14, 2010

(51) Int. Cl. G06F 9/44

(52) U.S. Cl. 717/168

(57) ABSTRACT

A method, system, and computer usable program product for creating a superseding software product release are provided in the illustrative embodiments. A first set of metadata describing a set of parts related to a first release is received at an application executing in a computer. A second set of metadata describing a second set of parts related to a second release is received. Using the first and the second sets of metadata, a part to be added to the second set of metadata is identified such that the second release is sufficient to supersede the first release. The second set of metadata is updated to include metadata of the part such that an updated second release according to the updated second set of metadata is sufficient to supersede the first release.

### BACKGROUND OF THE INVENTION

1. Field of the Invention

The present invention relates generally to an improved data processing system, and in particular, to a computer implemented method for packaging software products. Still more particularly, the present invention relates to a computer implemented method, system, and computer usable program code for creating a superseding software product release.

2. Description of the Related Art

A software package is often updated through a series of releases. A base release of a software product is a version of the software product that is considered the latest release of the software.

As is the nature of software, hardly any software code is completely error free, and over time, flaws or bugs are discovered in the software that have to be remedied. Software manufacturers often release interim or intermediate releases to address flaws, bugs, errors, incompatibilities, vulnerabilities, or other types of improvements. Intermediate releases are often designed to be smaller than the base release so that they may be tested and released to market quicker than the base release to address specific issues. Any number of intermediate releases may be released.

A future release that is to take the place of a current release is called a superseding release. A superseding release may supersede another intermediate release. Upon release the superseding release becomes the current intermediate release in such cases. A superseding release may also be packaged to supersede the base release. Upon release, such a superseding release becomes the current base release of the software product. After a superseding release is published, the whole cycle of intermediate releases and superseding release can iterate again.

### SUMMARY OF THE INVENTION

The illustrative embodiments provide a method, system, and computer usable program product for creating a superseding software package release. An embodiment receives, at an application executing in a computer, a first set of metadata describing a set of parts related to a first release. The embodiment receives a second set of metadata describing a second set of parts related to a second release. The embodiment identifies using the first and the second sets of metadata a part to be added to the second set of metadata such that the second release is sufficient to supersede the first release. The embodiment updates the second set of metadata to include metadata of the part such that an updated second release according to the updated second set of metadata is sufficient to supersede the first release.

### BRIEF DESCRIPTION OF THE DRAWINGS

The novel features believed characteristic of the invention are set forth in the appended claims. The invention itself; however, as well as a preferred mode of use, further objectives and advantages thereof, will best be understood by reference to the following detailed description of an illustrative embodiment when read in conjunction with the accompanying drawings, wherein:

FIG. 1 depicts a pictorial representation of a network of data processing systems in which the illustrative embodiments may be implemented;

FIG. 2 depicts a block diagram of a data processing system in which the illustrative embodiments may be implemented;

FIG. 3 depicts a block diagram of a software packaging tool in accordance with an illustrative embodiment;

FIG. 4 depicts a block diagram of release metadata in accordance with an illustrative embodiment;

FIG. 5 depicts a block diagram of an example part object in accordance with an illustrative embodiment;

FIG. 6 depicts a block diagram of an operation of a software packaging tool in accordance with an illustrative embodiment;

FIG. 7 depicts a block diagram of packaging a new release of a software product in accordance with an illustrative embodiment;

FIG. 8 depicts a flowchart of a portion of a process for creating a superseding software product release in accordance with an illustrative embodiment;

FIG. 9 depicts a flowchart of another portion of a process for creating a superseding software product release in accordance with an illustrative embodiment;

FIG. 10 depicts a flowchart of another portion of a process for creating a superseding software product release in accordance with an illustrative embodiment;

FIG. 11 depicts a flowchart of another portion of a process for creating a superseding software product release in accordance with an illustrative embodiment;

FIG. 12 depicts a flowchart of another portion of a process for creating a superseding software product release in accordance with an illustrative embodiment; and

FIG. 13 depicts a flowchart of another portion of a process for creating a superseding software product release in accordance with an illustrative embodiment.

### DETAILED DESCRIPTION OF THE PREFERRED EMBODIMENT

The invention recognizes that presently available methods of creating a superseding product release package are deficient in several respects. For example, the invention recognizes that many existing processes are largely manual comparison of the contents of previous releases, whether base or intermediate, with the contents of the intended superseding release and adjusting the superseding release package contents as necessary. The invention recognizes that while manual comparison may be a workable solution or small software products having less than a threshold number of package contents, the manual method is error prone and tedious for larger software packages.

As another example, the invention recognizes that some existing processes that do include some degree of automation for creating superseding releases are limited in the type of release content they can automatically process. For example, an existing tool may only be capable of examining Java® archive (JAR) files and the process resorts to a manual process for other types of contents. (Java is a registered trademark of Sun Microsystems, Inc. or Oracle Corporation in the United States and other countries.)

Furthermore, even if a process has some automation, such as the above existing process for handling JAR files, such existing process appears in a different phase of release planning. For example, the above example existing process that compares JAR files does so after the JAR file of the superseding package has been created with the contents of the release. In other words, the superseding package has to be created first, and then the existing automated processes identify any other code segments that may be needed for deploying the JAR file.

The invention recognizes that present methods of packaging a release of a software product are either inefficient or appear after the release contents are packaged, thereby requiring the superseding release to include the release contents and supplemental contents to make the superseding release deployable. Therefore, the invention recognizes that presently, a process for releasing superseding software product releases does not automatically create a superseding release manifest or metadata that can be utilized in packaging the superseding release that is ready for deployment.

Furthermore, the invention recognizes that existing processes, whether manual or partially automated, are platform centric. In other words, an existing process treats a release differently for each operating system platform for which the product is being released. A present method for packaging a software release is deficient in creating a release manifest or metadata that is uniformly applicable for packaging releases across multiple platforms.

The illustrative embodiments used to describe the invention generally address and solve the above-described problems and other problems related to releasing software products. The illustrative embodiments of the invention provide a method, computer usable program product, and data processing system for creating a superseding software product release.

An embodiment of the invention can be used for creating a release content list, or release manifest, and for creating accompanying metadata, creating data describing installability requirements or parts on the release manifest, before the release contents are packaged in any particular form. In so doing, an embodiment enables the superseding release package to be complete and ready for deployment without requiring post-packaging processing to determine any missing parts or metadata for a successful deployment.

Furthermore, an embodiment of the invention allows for creating a platform-neutral superseding release so that the resulting superseding package is deployable across a variety of platforms without platform-specific modifications. An embodiment automates the process of creating the superseding package and may remove certain inefficiencies or inaccuracies associated with any manual steps in the present processes.

The illustrative embodiments are described with respect to data, data structures, and identifiers only as examples. Such descriptions are not intended to be limiting on the invention. For example, an illustrative embodiment described with respect to a release data structure may be implemented using a combination of several pieces of information from different sources, in a similar manner within the scope of the invention.

Furthermore, the illustrative embodiments may be implemented with respect to any type of data processing system. For example, an illustrative embodiment may be implemented with respect to any type of client system, server system, platform, or a combination thereof.

The illustrative embodiments are further described with respect to certain parameters, attributes, operations, manipulations, and configurations only as examples. Such descriptions are not intended to be limiting on the invention. For example, an illustrative embodiment described with respect to a particular property of an object can be similarly implemented using other attribute of another comparable data structure, in a similar manner within the scope of the invention.

An application implementing an embodiment may take the form of data objects, code objects, encapsulated instructions, application fragments, drivers, routines, services, systems—including basic I/O system (BIOS), and other types of software implementations available in a data processing environment. For example, Java® Virtual Machine (JVM®), Java® object, an Enterprise Java Bean (EJB®), a servlet, or an applet may be manifestations of an application with respect to which, within which, or using which, the invention may be implemented. (Java, JVM, EJB, and other Java related terminologies are registered trademarks of Sun Microsystems, Inc. or Oracle Corporation in the United States and other countries.)

An illustrative embodiment may be implemented in hardware, software, or a combination thereof. The examples in this disclosure are used only for the clarity of the description and are not limiting on the illustrative embodiments. Additional or different information, data, operations, actions, tasks, activities, and manipulations will be conceivable from this disclosure for similar purpose and the same are contemplated within the scope of the illustrative embodiments.

The illustrative embodiments are described using specific code, file systems, designs, architectures, layouts, schematics, and tools only as examples and are not limiting on the illustrative embodiments. Furthermore, the illustrative embodiments are described in some instances using particular data processing environments, such as a helpdesk environment, only as an example for the clarity of the description. The illustrative embodiments may be used in conjunction with other comparable or similarly purposed structures, systems, applications, or architectures.

Any advantages listed herein are only examples and are not intended to be limiting on the illustrative embodiments. Additional or different advantages may be realized by specific illustrative embodiments. Furthermore, a particular illustrative embodiment may have some, all, or none of the advantages listed above.

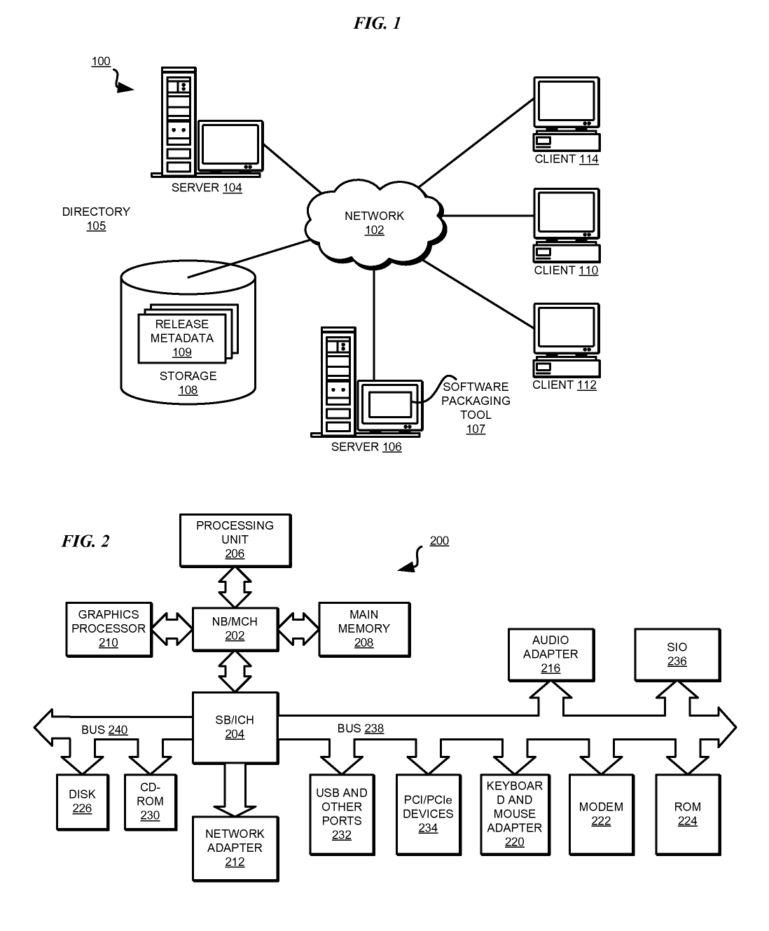

With reference to the figures and in particular with reference to FIGS. 1 and 2, these figures are example diagrams of data processing environments in which illustrative embodiments may be implemented. FIGS. 1 and 2 are only examples and are not intended to assert or imply any limitation with regard to the environments in which different embodiments may be implemented. A particular implementation may make many modifications to the depicted environments based on the following description.

FIG. 1 depicts a pictorial representation of a network of data processing systems in which illustrative embodiments may be implemented. Data processing environment 100 is a network of computers in which the illustrative embodiments may be implemented. Data processing environment 100 includes network 102. Network 102 is the medium used to provide communications links between various devices and computers connected together within data processing environment 100. Network 102 may include connections, such as wire, wireless communication links, or fiber optic cables. Server 104 and server 106 couple to network 102 along with storage unit 108. Software applications may execute on any computer in data processing environment 100.

In addition, clients 110, 112, and 114 couple to network 102. A data processing system, such as server 104 or 106, or client 110, 112, or 114 may contain data and may have software applications or software tools executing thereon.

Server 104 may software packaging tool 105. Software packaging tool 105 may be an application capable of preparing a software product release package in accordance with an illustrative embodiment. Storage 108 may include release metadata 109. Release metadata 109 may be structured data identifying the contents of a release including the contents' properties in accordance with an illustrative embodiment. For example, release metadata 109 for a particular release may be metadata related to a release manifest of that release organized with information according to an embodiment. Release metadata 109, and the term “metadata” generally, refers to a set of one or more pieces of information that may be used as metadata.

Servers 104 and 106, storage unit 108, and clients 110, 112, and 114 may couple to network 102 using wired connections, wireless communication protocols, or other suitable data connectivity. Clients 110, 112, and 114 may be, for example, personal computers or network computers.

In the depicted example, server 104 may provide data, such as boot files, operating system images, and applications to clients 110, 112, and 114. Clients 110, 112, and 114 may be clients to server 104 in this example. Clients 110, 112, 114, or some combination thereof, may include their own data, boot files, operating system images, and applications. Data processing environment 100 may include additional servers, clients, and other devices that are not shown.

In the depicted example, data processing environment 100 may be the Internet. Network 102 may represent a collection of networks and gateways that use the Transmission Control Protocol/Internet Protocol (TCP/IP) and other protocols to communicate with one another. At the heart of the Internet is a backbone of data communication links between major nodes or host computers, including thousands of commercial, governmental, educational, and other computer systems that route data and messages. Of course, data processing environment 100 also may be implemented as a number of different types of networks, such as for example, an intranet, a local area network (LAN), or a wide area network (WAN). FIG. 1 is intended as an example, and not as an architectural limitation for the different illustrative embodiments.

Among other uses, data processing environment 100 may be used for implementing a client server environment in which the illustrative embodiments may be implemented. A client server environment enables software applications and data to be distributed across a network such that an application functions by using the interactivity between a client data processing system and a server data processing system. Data processing environment 100 may also employ a service oriented architecture where interoperable software components distributed across a network may be packaged together as coherent business applications.

With reference to FIG. 2, this figure depicts a block diagram of a data processing system in which illustrative embodiments may be implemented. Data processing system 200 is an example of a computer, such as server 104 or client 110 in FIG. 1, in which computer usable program code or instructions implementing the processes may be located for the illustrative embodiments.

In the depicted example, data processing system 200 employs a hub architecture including North Bridge and memory controller hub (NB/MCH) 202 and south bridge and input/output (I/O) controller hub (SB/ICH) 204. Processing unit 206, main memory 208, and graphics processor 210 are coupled to north bridge and memory controller hub (NB/MCH) 202. Processing unit 206 may contain one or more processors and may be implemented using one or more heterogeneous processor systems. Graphics processor 210 may be coupled to the NB/MCH through an accelerated graphics port (AGP) in certain implementations. In some configurations, processing unit 206 may include NB/MCH 202 or parts thereof.

In the depicted example, local area network (LAN) adapter 212 is coupled to south bridge and I/O controller hub (SB/ICH) 204. Audio adapter 216, keyboard and mouse adapter 220, modem 222, read only memory (ROM) 224, universal serial bus (USB) and other ports 232, and PCI/PCIe devices 234 are coupled to south bridge and I/O controller hub 204 through bus 238. Hard disk drive (HDD) 226 and CD-ROM 230 are coupled to south bridge and I/O controller hub 204 through bus 240. PCI/PCIe devices may include, for example, Ethernet adapters, add-in cards, and PC cards for notebook computers. PCI uses a card bus controller, while PCIe does not. ROM 224 may be, for example, a flash binary input/output system (BIOS). In some configurations, ROM 224 may be an Electrically Erasable Programmable Read-Only Memory (EEPROM) or any other similarly usable device. Hard disk drive 226 and CD-ROM 230 may use, for example, an integrated drive electronics (IDE) or serial advanced technology attachment (SATA) interface. A super I/O (SIO) device 236 may be coupled to south bridge and I/O controller hub (SB/ICH) 204.

An operating system runs on processing unit 206. The operating system coordinates and provides control of various components within data processing system 200 in FIG. 2. The operating system may be a commercially available operating system such as AIX® (AIX is a trademark of International Business Machines Corporation in the United States and other countries), Microsoft® Windows® (Microsoft and Windows are trademarks of Microsoft Corporation in the United States and other countries), or Linux® (Linux is a trademark of Linus Torvalds in the United States and other countries). An object oriented programming system, such as the Java™ programming system, may run in conjunction with the operating system and provides calls to the operating system from Java™ programs or applications executing on data processing system 200 (Java is a trademark of Sun Microsystems, Inc., in the United States and other countries).

Instructions for the operating system, the object-oriented programming system, and applications or programs are located on storage devices, such as hard disk drive 226, and may be loaded into main memory 208 for execution by processing unit 206. The processes of the illustrative embodiments may be performed by processing unit 206 using computer implemented instructions, which may be located in a memory, such as, for example, main memory 208, read only memory 224, or in one or more peripheral devices.

The hardware in FIGS. 1-2 may vary depending on the implementation. Other internal hardware or peripheral devices, such as flash memory, equivalent non-volatile memory, or optical disk drives and the like, may be used in addition to or in place of the hardware depicted in FIGS. 1-2. In addition, the processes of the illustrative embodiments may be applied to a multiprocessor data processing system.

In some illustrative examples, data processing system 200 may be a personal digital assistant (PDA), which is generally configured with flash memory to provide non-volatile memory for storing operating system files and/or user-generated data. A bus system may comprise one or more buses, such as a system bus, an I/O bus, and a PCI bus. Of course, the bus system may be implemented using any type of communications fabric or architecture that provides for a transfer of data between different components or devices attached to the fabric or architecture.

A communications unit may include one or more devices used to transmit and receive data, such as a modem or a network adapter. A memory may be, for example, main memory 208 or a cache, such as the cache found in north bridge and memory controller hub 202. A processing unit may include one or more processors or CPUs.

The depicted examples in FIGS. 1-2 and above-described examples are not meant to imply architectural limitations. For example, data processing system 200 also may be a tablet computer, laptop computer, or telephone device in addition to taking the form of a PDA.

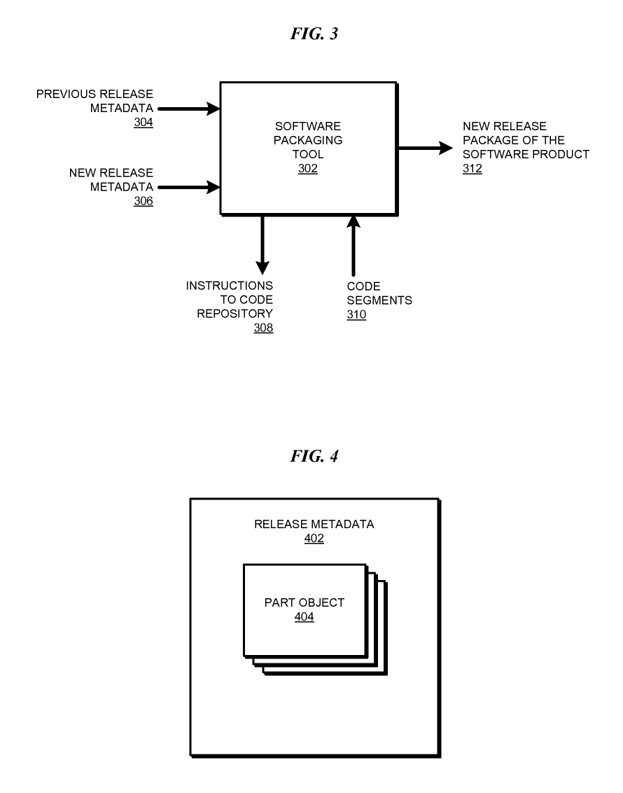

With reference to FIG. 3, this figure depicts a block diagram of a software packaging tool in accordance with an illustrative embodiment. Software packaging tool 302 may be implemented as software packaging tool 107 in FIG. 1.

Tool 302 receives as input, one or more previous release metadata 304. Previous release metadata 304 may be the release metadata of a base release, an intermediate release, or both. Tool 302 also receives as input, new release metadata 306. New release metadata 306 may be the release metadata of a planned superseding release. Previous release metadata 304 and new release metadata 306 may be organized with information according to an embodiment of the invention, such as described in the example of FIG. 4.

In one embodiment, new release metadata 306 may include information describing only the components necessary for the operation of the new release and not for superseding any previous releases. In another embodiment, new release metadata 306 may include information describing the components necessary for the operation of the new release, and information describing some but not all components needed for superseding any previous releases.

Tool 302 processes previous release metadata 304 and new release metadata 306 as described elsewhere in this disclosure. Upon such processing, tool 302 generates instruction 308 to a code repository. A code repository may be any form of storage of code segments of the software product. A code segment is a unit of code participating in the software product.

Tool 302 receives one or more code segments 310 from the code repository. Tool 302 uses received code segments 310 to prepare new release 312 of the software package.

With reference to FIG. 4, this figure depicts a block diagram of release metadata in accordance with an illustrative embodiment. Release metadata 402 may be used as previous release metadata 304 or new release metadata 306, or both, in FIG. 3.

Release metadata 402 may include one or more part object 404. An instance of part object 404 identifies a part included, excluded, added, deleted, or modified in the release represented by release metadata 402. As an example, an instance of part object 404 may be metadata usable to identify a code segment, documentation, data, or configuration information. Furthermore, such a release part may be identified in an instance of part object 404 by metadata including file name, a library locator, a resource locator, a location or pathname, a date, a version, ownership information, any other type of metadata information sufficient to locate the part, or a combination thereof. Additionally, an instance of part object 404 may also include as the part metadata, the part's position in a hierarchy, similar identifying information for a parent part of the part, similar identifying information for a child part of the part, similar identifying information for a related or dependent part of the part, similar identifying information for a recommended complimentary part of the part, or a combination thereof.

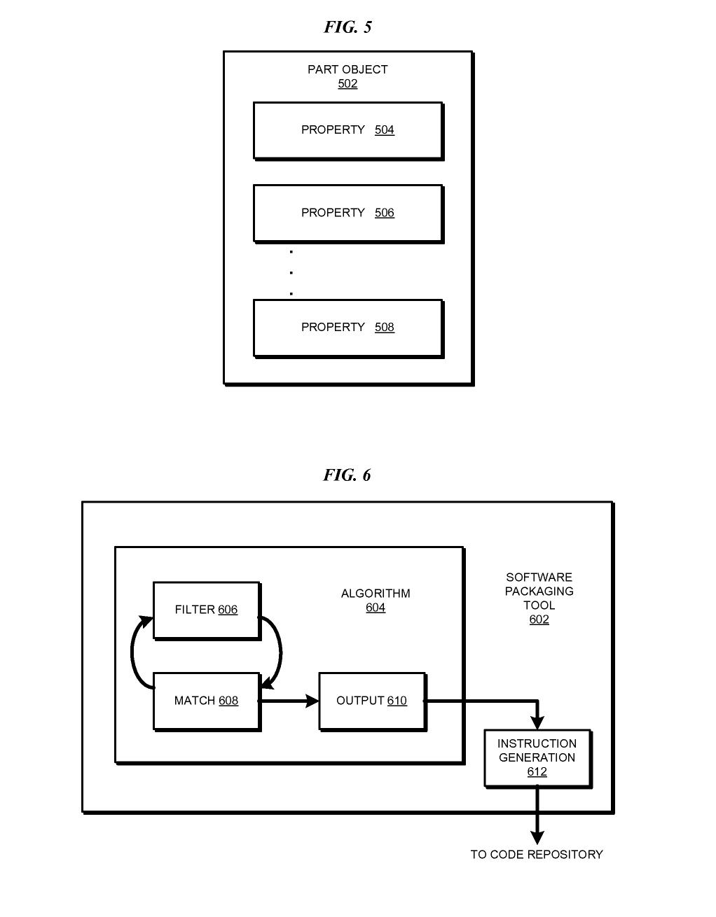

With reference to FIG. 5, this figure depicts a block diagram of an example part object in accordance with an illustrative embodiment. Part object 502 may be used as part object 404 in FIG. 4.

Part object 502 may include any number of properties such as properties 504, 506, and 508. Taking property 504 as an example, a property of part object 502 may be an attribute of part object 502 having a value. A property may also optionally include a name of the property. For example, in one embodiment, part object 502 may be a data structure having properties 504, 506, and 508 arranged and delimited in a specified order, without requiring a property to include an associated property name. In another example embodiment, part object 502 may be a data structure having property 504, 506, and 508 as name-value pair attributes.

Another example embodiment may include a property, such as property 504, that is itself a data structure having one or more delimited or name-value pair attributes. Another example embodiment may include a combination of properties having delimited values, properties having name-value pairs, and properties including other attributes.

A property, for example, property 504, may include as the property's value a file name, a library locator, a resource locator, a location or pathname, a date, a version, ownership information, or any other type of information sufficient to locate the part represented by part object 502. Additionally, a property may also include as the property's value the part's position in a hierarchy, an identifying information for a parent part of part 502, similar identifying information for a child part of part 502, similar identifying information for a related or dependent part of part 502, similar identifying information for a recommended complimentary part of part 502, or a combination thereof.

With reference to FIG. 6, this figure depicts a block diagram of an operation of a software packaging tool in accordance with an illustrative embodiment. Software packaging tool 602 can be used as software packaging tool 302 in FIG. 3.

Tool 602 includes algorithm 604. Algorithm 604 is configured to accept two or more release metadata, such as an intermediate release metadata or base release metadata, and a new release metadata, as inputs. Algorithm 604 filters 606 and matches 608 certain parts information from the input metadata. The filtering and matching operation of algorithm 604 will become clearer from the description of FIGS. 8-13.

Output 610 is a result of filtering 606 and matching 608. In output 610, algorithm 604 outputs information about parts that should be added, deleted, or modified in the input new release metadata such that a new release package of the software product will be suitable for superseding prior releases of the software product.

Instruction generation component 612 of tool 602 may generate one or more instructions to a code segment according to output 610. For example, output 610 may identify a part, e.g., a code segment, from an input intermediate release metadata that was deleted in the intermediate release but has been added back in the new release according to the input new release metadata. Accordingly, instruction generation component 612 may generate an instruction for a code repository to reset a delete flag for the code segment so that the code segment can be included in a later build, e.g., the new release.

As another example, output 610 may identify a part from an input intermediate release metadata that was deleted in the intermediate release and remains deleted in the new release according to the input new release metadata. Accordingly, instruction generation component 612 may generate an instruction for a code repository to indicate for the code segment that the code segment has been deleted in the new release instead of, or in addition to, having been deleted in the intermediate release.

The example operations described above as well as with respect to FIGS. 8-13 are not intended to be limiting on the invention. Many other similar operations for ensuring that the new release is sufficient to supersede an older release will be apparent from this disclosure to those of ordinary skill in the art, and the same are contemplated within the scope of the invention. Example, an implementation may supersede a base release that is older than the current base release using an embodiment in a similar manner. As another example, an implementation may supersede some intermediate releases but not all using suitable metadata for filtering and matching without departing the scope of the invention.

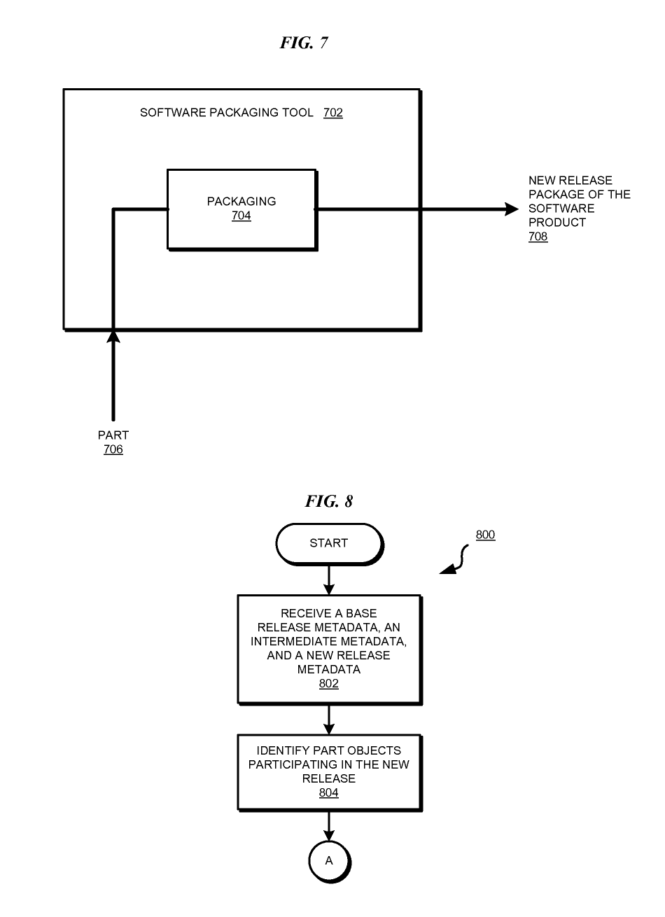

With reference to FIG. 7, this figure depicts a block diagram of packaging a new release of a software product in accordance with an illustrative embodiment. Software packaging tool 702 may be implemented as software packaging tool 302 in FIG. 3.

Packaging component 704 of tool 702 receives one or more parts 706 to include in new release package 708 of the software product. For example, in response to the instructions from instruction generation component 612 in FIG. 6, the code repository may modify information pertaining to an appropriate part, e.g., a code segment, of new or older release. The code repository may then provide the modified part, e.g., the modified code segment or an executable version thereof, as part 706 to packaging component 704 for including in new release package 708.

As another example, in response to the instructions from instruction generation component 612 in FIG. 6, a document library may amend the documentation pertaining to an appropriate part, e.g., a feature description, of new or older release. The document library may then provide the modified documentation as part 706 to packaging component 704 for including in new release package 708.

In one embodiment, packaging component 704 may not produce new release package 708 but a revised new release metadata, or new release manifest. Another component (not shown) may use the revised metadata or manifest to assemble new release package 708 within the scope of the invention.

With reference to FIG. 8, this figure depicts a flowchart of a portion of a process for creating a superseding software product release in accordance with an illustrative embodiment. Process 800 may be implemented in a software packaging tool algorithm, such as algorithm 604 in FIG. 6.

Process 800 begins by receiving an intermediate release metadata, a base release metadata, and a new release metadata (step 802). Receiving a base release metadata in step 802 may be optional in one embodiment. Process 800 may receive multiple metadata documents for any level of release for any number of levels of releases in step 802.

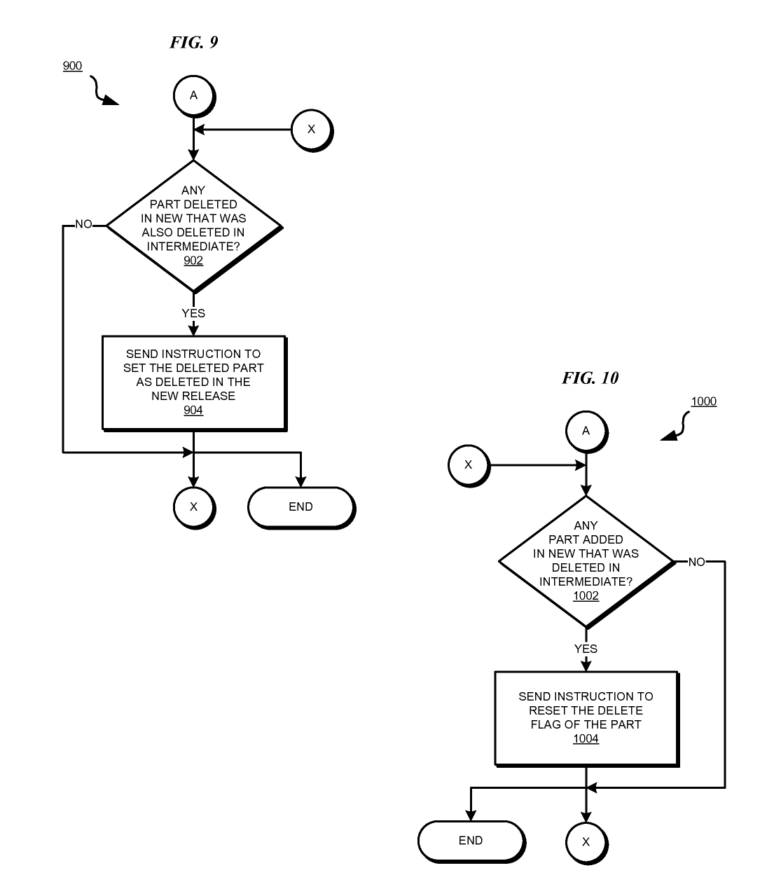

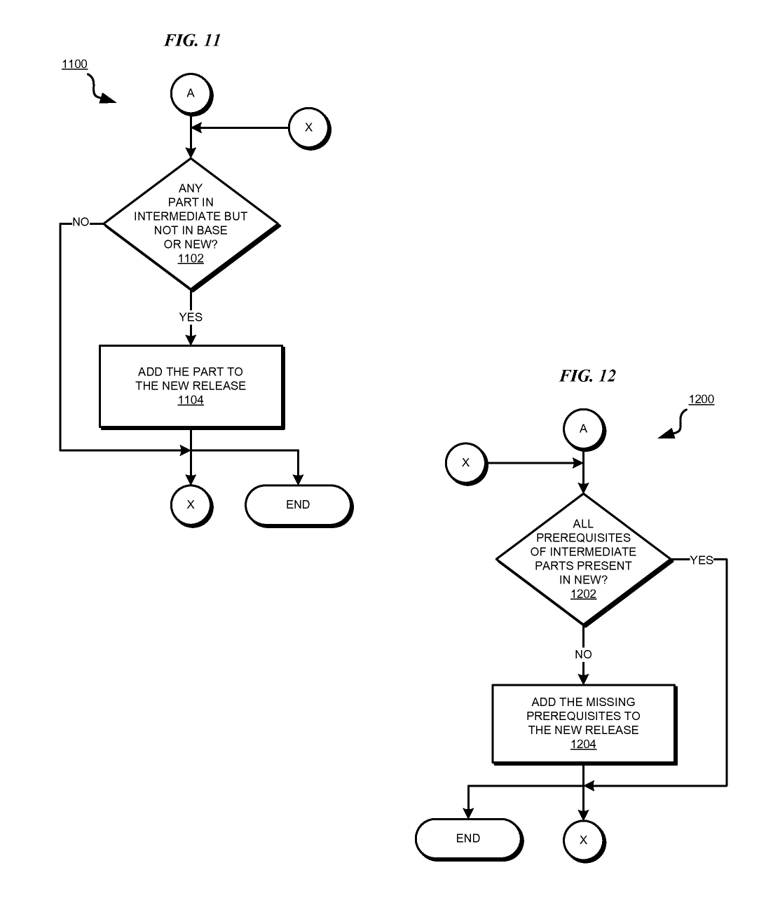

Process 800 identifies those part objects that should participate in the new release (step 804). Step 804 triggers suitable filtering and matching mechanisms, as depicted in FIG. 9-12, depending on the contents of the various metadata inputs received in step 802. Process 800 exits at exit point marked “A” to enter another process having a corresponding entry point marked “A”, such as process 900 in FIG. 9, process 1000 in FIG. 10, process 1100 in FIG. 11, or process 1200 in FIG. 12.

With reference to FIG. 9, this figure depicts a flowchart of another portion of a process for creating a superseding software product release in accordance with an illustrative embodiment. Process 900 may be implemented in a software packaging tool algorithm, such as algorithm 604 in FIG. 6.

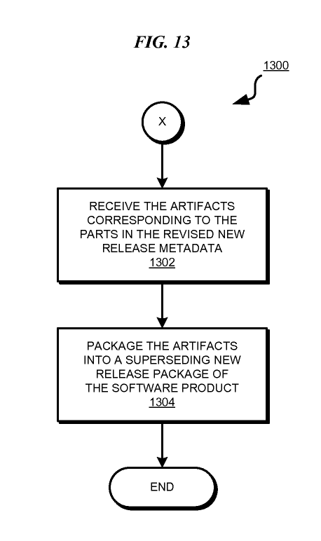

Another process, such as process 800 in FIG. 8 may enter process 900 at entry point marked “A”, and begin by determining whether any part that is being deleted in the new release was also deleted in another prior release, such as an intermediate release, (step 902). If so (“Yes” path of step 902), process 900 sends an instruction to set a property of an artifact corresponding to the deleted part to reflect that the part is deleted in the new release, instead of or in addition to having been deleted in the prior release (step 904). Following step 904, or if no part is being deleted in the new release that was also deleted in another prior release (“No” path of step 902), process 900 may end thereafter. Alternatively, process 900 then exit at exit point marked “X”. Process 900 may loop back to step 902 at the entry point marked “X” to find additional such parts, or enter another process having a corresponding entry point marked “X”, such as process 1000 in FIG. 10, process 1100 in FIG. 11, process 1200 in FIG. 12, or process 1300 in FIG. 13.

With reference to FIG. 10, this figure depicts a flowchart of another portion of a process for creating a superseding software product release in accordance with an illustrative embodiment. Process 1000 may be implemented in a software packaging tool algorithm, such as algorithm 604 in FIG. 6.

Another process, such as process 800 in FIG. 8 may enter process 1000 at entry point marked “A”, and begin by determining whether any part that is being added in the new release was deleted in another prior release, such as an intermediate release, (step 1002). If so (“Yes” path of step 1002), process 1000 sends an instruction to reset a delete indicator, such as a delete flag, of an artifact corresponding to the deleted part to allow the part to be added in the new release (step 1004). Following step 1004, or if no part is being added in the new release that was deleted in another prior release (“No” path of step 1002), process 1000 may end thereafter. Alternatively, process 1000 may then exit at exit point marked “X”. Process 1000 may loop back to step 1002 at the entry point marked “X” to find additional such parts, or enter another process having a corresponding entry point marked “X”, such as process 900 in FIG. 9, process 1100 in FIG. 11, process 1200 in FIG. 12, or process 1300 in FIG. 13.

With reference to FIG. 11, this figure depicts a flowchart of another portion of a process for creating a superseding software product release in accordance with an illustrative embodiment. Process 1100 may be implemented in a software packaging tool algorithm, such as algorithm 604 in FIG. 6.

Another process, such as process 800 in FIG. 8 may enter process 1100 at entry point marked “A”, and begin by determining whether any part is included in an intermediate release but is not present in either the base release or the new release (step 1102). If so (“Yes” path of step 1102), process 1000 adds the part, parts information, or both, to the new release, such as in an updated new release metadata or manifest (step 1104). Following step 1104, or if no such part is identified in an intermediate release (“No” path of step 1102), process 1100 may end thereafter.

Alternatively, process 1100 may then exit at exit point marked “X”. Process 1100 may loop back to step 1102 at the entry point marked “X” to find additional such parts, or enter another process having a corresponding entry point marked “X”, such as process 900 in FIG. 9, process 1000 in FIG. 10, process 1200 in FIG. 12, or process 1300 in FIG. 13. For example, process 1100 may add parts information to a manifest in step 1104. Process 1100 may then enter process 1300 in FIG. 13 to retrieve the corresponding parts and assemble the release package.

With reference to FIG. 12, this figure depicts a flowchart of another portion of a process for creating a superseding software product release in accordance with an illustrative embodiment. Process 1200 may be implemented in a software packaging tool algorithm, such as algorithm 604 in FIG. 6.

Another process, such as process 800 in FIG. 8 may enter process 1200 at entry point marked “A”, and begin by determining whether all prerequisite parts for a part in an intermediate release are included in the new release (step 1202). As an example, a code segment part of an intermediate release may have a parent code segment that may be necessary for the execution of the code segment. The parent part may be a prerequisite part in process 1200. As another example, a code segment part may implement a feature that may function only if another feature is also implemented. The code segment part implementing the other feature may be a prerequisite part in process 1200. Many other forms of dependencies will be apparent from this disclosure to those of ordinary skill in the art, and prerequisite parts to satisfy those dependencies are contemplated within the scope of the invention.

If a prerequisite part is missing (“No” path of step 1202), process 1200 adds the missing prerequisite parts to the new release, such as in an updated new release metadata or manifest (step 1204). For example, the prerequisite parts list may change based on parts that are added or deleted from a release, such as by process 900 in FIG. 9, process 1000 in FIG. 10, or process 1100 in FIG. 11. For example, when a part is deleted from a release, all or some prerequisites for that part may also become removable from the release. Likewise, when a part is added to a release, the prerequisites list may have to be updated as well to ensure that all prerequisites of the newly added parts are also present in the release.

Following step 1204, or if no prerequisite part is missing (“Yes” path of step 1202), process 1200 may end thereafter. Alternatively, process 1200 may then exit at exit point marked “X”. Process 1200 may loop back to step 1202 at the entry point marked “X” to find additional such prerequisite parts, or enter another process having a corresponding entry point marked “X”, such as process 900 in FIG. 9, process 1000 in FIG. 10, process 1100 in FIG. 11, or process 1300 in FIG. 13.

With reference to FIG. 13, this figure depicts a flowchart of another portion of a process for creating a superseding software product release in accordance with an illustrative embodiment. Process 1300 may be implemented in a software packaging tool algorithm, such as algorithm 604 in FIG. 6.

Another process, such as process 900 in FIG. 9, process 1000 in FIG. 10, process 1100 in FIG. 11, or process 1200 in FIG. 12, may enter process 1300 at entry point marked “X”, and begin by receiving one or more artifacts corresponding to the parts in the revised new release metadata or manifest (step 1302). Process 1300 packages the artifacts into a superseding new release package of the software product (step 1304). Process 1300 ends thereafter.

The components in the block diagrams and the steps in the flowcharts described above are described only as examples. The components and the steps have been selected for the clarity of the description and are not limiting on the illustrative embodiments of the invention. For example, a particular implementation may combine, omit, further subdivide, modify, augment, reduce, or implement alternatively, any of the components or steps without departing from the scope of the illustrative embodiments. Furthermore, the steps of the processes described above may be performed in a different order within the scope of the invention.

Thus, a computer implemented method, apparatus, and computer program product are provided in the illustrative embodiments for creating superseding software release. Using an embodiment of the invention, a new release of a software product can be packages such that the release is sufficient to supersede prior releases on multiple platforms. An embodiment efficiently and automatically generates a new release metadata, manifest, or both. An embodiment may also revise a proposed new release metadata, manifest, or both, for successfully superseding prior releases of the software product.

The invention can take the form of an entirely software embodiment, or an embodiment containing both hardware and software elements. In a preferred embodiment, the invention is implemented in software or program code, which includes but is not limited to firmware, resident software, and microcode.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Further, a computer storage medium may contain or store a computer-readable program code such that when the computer-readable program code is executed on a computer, the execution of this computer-readable program code causes the computer to transmit another computer-readable program code over a communications link. This communications link may use a medium that is, for example without limitation, physical or wireless.

A data processing system suitable for storing and/or executing program code will include at least one processor coupled directly or indirectly to memory elements through a system bus. The memory elements can include local memory employed during actual execution of the program code, bulk storage media, and cache memories, which provide temporary storage of at least some program code in order to reduce the number of times code must be retrieved from bulk storage media during execution.

A data processing system may act as a server data processing system or a client data processing system. Server and client data processing systems may include data storage media that are computer usable, such as being computer readable. A data storage medium associated with a server data processing system may contain computer usable code. A client data processing system may download that computer usable code, such as for storing on a data storage medium associated with the client data processing system, or for using in the client data processing system. The server data processing system may similarly upload computer usable code from the client data processing system. The computer usable code resulting from a computer usable program product embodiment of the illustrative embodiments may be uploaded or downloaded using server and client data processing systems in this manner.

Input/output or I/O devices (including but not limited to keyboards, displays, pointing devices, etc.) can be coupled to the system either directly or through intervening I/O controllers.

Network adapters may also be coupled to the system to enable the data processing system to become coupled to other data processing systems or remote printers or storage devices through intervening private or public networks. Modems, cable modem and Ethernet cards are just a few of the currently available types of network adapters.

The description of the present invention has been presented for purposes of illustration and description, and is not intended to be exhaustive or limited to the invention in the form disclosed. Many modifications and variations will be apparent to those of ordinary skill in the art. The embodiment was chosen and described in order to explain the principles of the invention, the practical application, and to enable others of ordinary skill in the art to understand the invention for various embodiments with various modifications as are suited to the particular use contemplated.

What is claimed is:

1. A computer implemented method for creating a superseding release of a software product, comprising:
receiving, at an application executing in a computer, a first set of metadata describing a set of parts related to a first release;
receiving a second set of metadata describing a second set of parts related to a second release;
identifying using the first and the second sets of metadata a part to be added to the second set of metadata such that the second release is sufficient to supersede the first release; and
updating the second set of metadata to include metadata of the part such that an updated second release according to the updated second set of metadata is sufficient to supersede the first release.

2. The computer implemented method of claim 1, further comprising:
packaging a plurality of artifacts according to the parts in the updated second set of metadata to form the superseding release of the software product.

3. The computer implemented method of claim 1, wherein the part is deleted in the first set of metadata and added in the second set of metadata, further including:
sending an instruction to a repository to reset a delete attribute of an artifact associated with the part.

4. The computer implemented method of claim 1, wherein the part is deleted in the first set of metadata and deleted in the second set of metadata, further comprising:
sending an instruction to a repository to modify an attribute of an artifact associated with the part such that the artifact appears to have been deleted in the second release in the repository.

5. The computer implemented method of claim 1, wherein the part is a prerequisite part of another part in the first metadata, further comprising:
adding the part to the second set of metadata.

6. The computer implemented method of claim 1, wherein the second release is a proposed new release, the second set of metadata is a proposed manifest of the proposed new release, the proposed new release being insufficient to supersede the first release.

7. The computer implemented method of claim 1, wherein the first release is an intermediate release, wherein a set of metadata is a parts manifest, and wherein the set of parts of the first set of metadata includes a first subset of parts included in the first release, a second subset of parts deleted in the first release, and a third subset of parts that are prerequisites to the parts in the first subset.

8. A computer usable program product comprising a computer usable storage medium including computer usable code for creating a superseding release of a software product, the computer usable code comprising:
computer usable code for receiving, at an application executing in a computer, a first set of metadata describing a set of parts related to a first release;
computer usable code for receiving a second set of metadata describing a second set of parts related to a second release;
computer usable code for identifying using the first and the second sets of metadata a part to be added to the second set of metadata such that the second release is sufficient to supersede the first release; and
computer usable code for updating the second set of metadata to include metadata of the part such that an updated second release according to the updated second set of metadata is sufficient to supersede the first release.

9. The computer usable program product of claim 8, further comprising:
computer usable code for packaging a plurality of artifacts according to the parts in the updated second set of metadata to form the superseding release of the software product.

10. The computer usable program product of claim 8, wherein the part is deleted in the first set of metadata and added in the second set of metadata, further including:
computer usable code for sending an instruction to a repository to reset a delete attribute of an artifact associated with the part.

11. The computer usable program product of claim 8, wherein the part is deleted in the first set of metadata and deleted in the second set of metadata, further comprising:
computer usable code for sending an instruction to a repository to modify an attribute of an artifact associated with the part such that the artifact appears to have been deleted in the second release in the repository.

12. The computer usable program product of claim 8, wherein the part is a prerequisite part of another part in the first set of metadata, further comprising:
computer usable code for adding the part to the second set of metadata.

13. The computer usable program product of claim 8, wherein the second release is a proposed new release, the second set of metadata is a proposed manifest of the proposed new release, the proposed new release being insufficient to supersede the first release.

14. The computer usable program product of claim 8, wherein the first release is an intermediate release, wherein the set of parts of the first set of metadata includes a first subset of parts included in the first release, a second subset of parts deleted in the first release, and a third subset of parts that are prerequisites to the parts in the first subset.

15. The computer usable program product of claim 8, wherein the computer usable code is stored in a computer readable storage medium in a data processing system, and wherein the computer usable code is transferred over a network from a remote data processing system.

16. The computer usable program product of claim 8, wherein the computer usable code is stored in a computer readable storage medium in a server data processing system, and wherein the computer usable code is downloaded over a network to a remote data processing system for use in a computer readable storage medium associated with the remote data processing system.

17. A data processing system for creating a superseding release of a software product, the data processing system comprising:
a storage device including a storage medium, wherein the storage device stores computer usable program code; and
a processor, wherein the processor executes the computer usable program code, and wherein the computer usable program code comprises:
computer usable code for receiving, at an application executing in a computer, a first set of metadata describing a set of parts related to a first release;
computer usable code for receiving a second set of metadata describing a second set of parts related to a second release;
computer usable code for identifying using the first and the second sets of metadata a part to be added to the second set of metadata such that the second release is sufficient to supersede the first release; and
computer usable code for updating the second set of metadata to include metadata of the part such that an updated second release according to the updated second set of metadata is sufficient to supersede the first release.

18. The data processing system of claim 17, further comprising:
computer usable code for packaging a plurality of artifacts according to the parts in the updated second set of metadata to form the superseding release of the software product.

19. The data processing system of claim 17, wherein the part is deleted in the first set of metadata and added in the second set of metadata, further including:
computer usable code for sending an instruction to a repository to reset a delete attribute of an artifact associated with the part.

20. The data processing system of claim 17, wherein the part is deleted in the first set of metadata and deleted in the second set of metadata, further comprising:
computer usable code for sending an instruction to a repository to modify an attribute of an artifact associated with the part such that the artifact appears to have been deleted in the second release in the repository.
